(19) United States
(12) Patent Application Publication
(10) Pub. No.: US 2019/0278915 A1
(43) Pub. Date: Sep. 12, 2019

(54) METHOD FOR SECURE BOOT USING SIGNED PUBLIC KEY

(71) Applicant: SECURITYPLATFORM, Seongnam-si (KR)

(72) Inventors: Kyung Mo KIM, Seongnam-si (KR); Yong Kwan PARK, Seongnam-si (KR)

(73) Assignee: SECURITYPLATFORM, Seongnam-si (KR)

(21) Appl. No.: 16/345,499

(22) PCT Filed: Sep. 20, 2017
(86) PCT No.: PCT/KR2017/010352

§ 371 Date: Apr. 26, 2019

(30) Foreign Application Priority Data
Nov. 3, 2016 (KR) 10-2016-0145706

(51) Int. Cl. G06F 21/57; H04L 9/30; H04L 9/32

(52) U.S. Cl. CPC G06F 21/575; H04L 9/30; G06F 2221/034; G06F 21/572; H04L 9/3247

(57) ABSTRACT

A method for secure boot of a device through verification of a plurality of managers includes maintaining a first boot image and a first public key of a first manager; executing the first boot image; maintaining a second boot image and a second public key of a second manager signed by the first manager; verifying integrity of the second public key using the first public key; verifying integrity of the second boot image using the verified second public key when the integrity of the second public key is verified; executing the second boot image when the integrity of the second boot image is verified; maintaining a third boot image signed by the second manager; verifying the integrity of the third boot image using the second public key; and executing the third boot image when the integrity of the third boot image is verified.

### TECHNICAL FIELD

The present invention relates to system booting and more particularly, to a method for system secure boot which may be managed by a plurality of subjects.

### BACKGROUND ART

Electronic devices are becoming gradually complicated and include a variety of information. As a result of the development of the Internet of Things and the like, one device serves as a security defect such as personal information exchange, remote operation, and the like while communicating with another device or a user.

FIG. 1 is a diagram for describing a booting method in the related art.

Referring to FIG. 1, in the system booting in the related art, generally, a first manager corresponding to a manufacturer provides firmware FW signed by a first private key PrK1 and a first public key PuK1 corresponding to the first private key is stored in the device. Therefore, when a first loader LD1 is executed, the signature of the firmware FW is verified by the stored first public key PuK1, and when it is confirmed that the firmware FW is signed with the first private key PrK1, the process of executing the firmware FW is performed.

In this case, when the integrity is verified with the public key, somewhat secure booting is possible. However, such system booting in the related art may have some problems in certain cases. Specifically, in the conventional method, only the subject possessing the private key that is initially signed may be signed, and a control right for the firmware may be limited to a single subject. However, there is a problem in that the plurality of subjects are authorized to have the ownership or management authority.

As an example, when there is a device seller or provider entrusting manufacture to a plurality of manufacturers, in the case where it is necessary to apply the secure boot in these devices, the seller or provider needs to distribute their private keys for signing to many manufacturers, and in this case, there is a problem in security.

Further, on the contrary, when a plurality of sellers or providers uses a device supplied from one manufacturer, one public key needs to be fixed to apply the secure boot. If the device supplied to many providers can be singed with one public key, there is a problem in security, and if the device is signed with a different private key for each provider, there is a problem in that a device manufactured for any one provider may not be changed to a device for the other provider, and as a result, there is a problem in that cost of inventory management may occur.

Further, when a development kit or device with the secure boot is sold to an individual, the individual becomes a subject of the signature, and when the same private key is distributed to the purchasing individuals, the meaning as a private key is fading, which may also be a problem.

### DISCLOSURE

### Technical Problem

An object of the present invention is to provide a method for secure boot capable of generating and authenticating a safe signature with each private key without sharing a specific private key, when there is a device seller or provider entrusting manufacture to a plurality of manufacturers or when a plurality of sellers or providers uses a device supplied from one manufacturer.

Another object of the present invention is to provide a method for secure boot capable of implementing safe device booting using each private key without sharing the same private key even though an individual purchases a device such as commercial, off-the-shelf (COTS) or other development kits.

### Technical Solution

In order to achieve the objects of the present invention, according to an embodiment of the present invention, there is provided a method for secure boot of a device through verification of a plurality of managers including: maintaining a first boot image and a first public key of a first manager; executing the first boot image; maintaining a second boot image and a second public key of a second manager signed by the first manager; verifying integrity of the second public key using the first public key; verifying integrity of the second boot image using the verified second public key when the integrity of the second public key is verified; executing the second boot image when the integrity of the second boot image is verified; maintaining a third boot image signed by the second manager; verifying the integrity of the third boot image using the second public key; and executing the third boot image when the integrity of the third boot image is verified.

In the present invention, the boot image may refer to a first loader, a second loader, a firmware, etc., and these boot images may be provided to be signed by a specific private key and provided to be encrypted using a symmetric key or the like.

Further, in the present invention, the ‘maintaining’ means a state to be permanently or temporarily stored for executing or using the boot image or the security key, and in order to maintaining the boot image or the security key, contents stored in a storage device such as a ROM may be called and may be received in real time, periodically, or aperiodically via a network.

Further, two or more management subjects, such as a first manager and a second manager, may be targeted, and the first manager may be a manufacturer and the second manager may be a provider or seller, but the first manager may be a provider and the second manger may be a manufacturer.

In the embodiment, the first public key of the first manager is used to verify the signature of the second public key of the second manager and the second manager has no need to provide the private key of the second manager to the first manager. In addition, since the signatures of the first manager and the second manager are each valid and there is no need to share a private key with each other, the first manager has no need to publish the private key of the first manager by signing the public key of the second manager differently, and may access each of the second managers individually.

The second public key of the second manager may be provided to be signed by the private key of the first manager and the third boot image may be provided to be signed by the private key of the second manager.

In the embodiment, the public key of the first manager may be stored in a ROM, an OTP device, or the like.

### Advantageous Effects

According to the method for secure boot of the present invention, the public key of the first manager used in the first boot loader is separated from the public key of the second manager used in the second boot image or the second loader, and in order to verify that the public key used in the second boot image and the like is entrusted from the first manager, a signature is added to the second public key with the private key of the first manager.

Accordingly, the first manager signs the public key of the second manager corresponding to the second boot image and the second manager may sign the firmware of only the second manager with the private key of the second manager to manage the safe booting of the device.

Further, it is possible for a manufacturer, a provider or a seller to generate and authenticate a safe signature with each private key without sharing a specific private key, when there is a device seller or provider entrusting manufacture to a plurality of manufacturers or even when a plurality of sellers or providers uses a device supplied from one manufacturer.

### DESCRIPTION OF DRAWINGS

FIG. 1 is a diagram for describing a booting method in the related art.

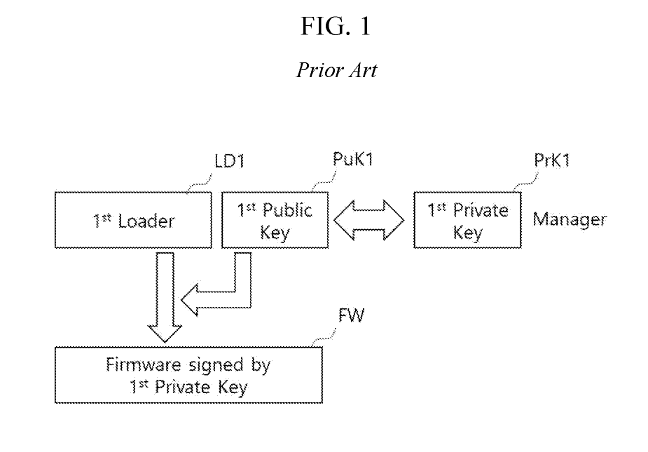

FIG. 2 is a diagram for describing a method for secure boot of a device according to an embodiment of the present invention.

### MODES OF THE INVENTION

Hereinafter, embodiments of the present invention will be described in detail with reference to the accompanying drawings, but the present invention is not limited or restricted to the embodiments. For reference, in the description, like reference numerals substantially refer to like elements, which may be described by citing contents disclosed in other drawings under such a rule and contents determined to be apparent to those skilled in the art or repeated may be omitted.

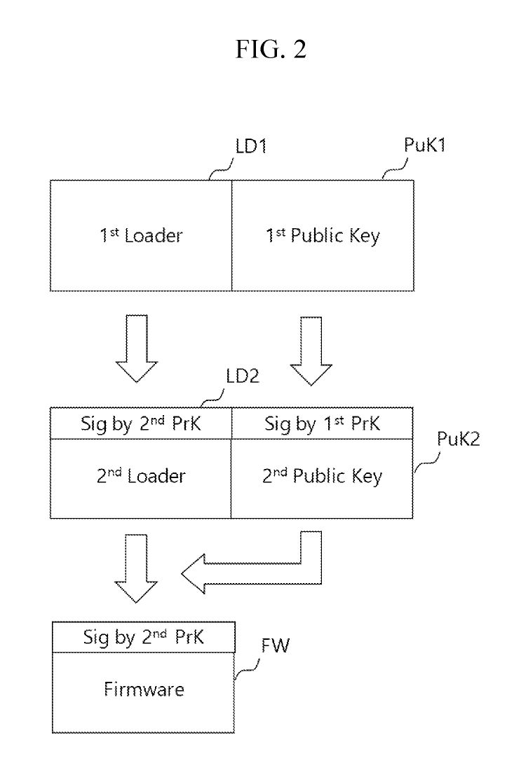

FIG. 2 is a diagram for describing a method for secure boot of a device according to an embodiment of the present invention.

Referring to FIG. 2, a method for secure boot according to the embodiment may be applied from the beginning of the power-on, and may be a part of the boot process that proceeds sequentially after an initial boot-loader. According to the method for secure boot, a first loader (first boot image) LD1 may be stored in a ROM-type storage device, and a first public key PuK1 may be stored together with the first loader LD1.

The first loader LD1 may be located in a boot ROM and the first loader LD1 is executed to execute a second loader LD2 or to verify a second public key PuK2 as described below. Generally, the first loader LD1 may be provided by the manufacturer, and the first public key PuK1 may correspond to the first private key of the manufacturer.

The first loader LD1 may verify the signature of the second public key PuK2 using the first public key PuK1. The second public key PuK2 corresponds to the second private key PrK2 of the second manger and may be signed by a first private key 1st PrK of the first manager. The first loader LD1 may verify the integrity of the second public key PuK2 using the first public key PuK1.

When the integrity of the second public key PuK2 is verified, the first loader LD1 may verify the integrity of the secondary loader LD2 using the second public key PuK2. The second loader LD2 may be signed by the second manager and may be signed by a second private key 2nd PrK of the second manager to be verified using the second public key PuK2. The second loader LD2 may be programmed or provided by the second manager.

When the integrity of the second loader LD2 is verified, the first loader LD1 may execute the second loader LD2. The second loader LD2 may perform functions to be performed by a general loader. For example, the second loader LD2 may perform operations such as very basic initialization or firmware update for operating firmware or kernel, and in the case of the firmware update, since the firmware itself may not be updated while the firmware normally operates, when rebooting is performed while an update file is stored in an internal temporary storage space, the second loader LD2 may update the firmware to the file. In addition, generally, various functions related to an interface for a peripheral device may be set and used. For example, only one of various functions is selected and used according to a board, and in such a case, a configuration such as selecting and using only a required function may be performed by the second loader LD2.

The second loader LD2 may verify the integrity of a third boot image, the firmware signed by the second manager in the embodiment using the second public key PuK2. As a result, also, the second public key PuK2 may be used and the second loader LD2 may confirm whether the firmware FW is provided by the second manager with the second public key PuK2.

When the integrity of the firmware FW is verified, the second loader LD2 may perform the third root image, for example, the firmware. In the embodiment, the firmware FW may be stored in a flash memory, and the firmware FW itself may be executable as it is or may be converted into a file executable through decryption.

In the embodiment, the first public key PuK1 of the first manager may be used to verify the signature of the second public key PuK2 of the second manager, and the first manager and the second manager need not to provide private keys to each other. Further, even though the first manager is one and the second manager is plural, the first manager verifies the signature only when the first boot image is converted into the second boot image and then verifies the signature by the public key of the second manager or the third manager to perform the management of the device without collision of the plurality of managers. Since only the first manager signs the public key of the second manager, even if the device is provided to another provider or seller, the device may be compatible with another provider or the like by varying only a public key to be signed.

The first manager stores the second loader signed by the second manager and the second public key signed by the second private key of the first manager in a flash memory or provides the second loader and the second public key to a network or the like to verify that the second public key PuK2 used by the second loader is entrusted from the first manager. Thereafter, the second manager signs the second loader LD2 with the private key of the second manager and signs the firmware of the second manager with the private key of the second manager to manage safe booting of the device.

As described above, the present invention has been described with reference to the preferred embodiments. However, it will be appreciated by those skilled in the art that various modifications and changes of the present invention can be made without departing from the spirit and the scope of the present invention which are defined in the appended claims and their equivalents.

1. A method for secure boot of a device through verification of a plurality of managers, comprising:
maintaining a first boot image and a first public key of a first manager;
executing the first boot image;
maintaining a second boot image and a second public key of a second manager signed by the first manager;
verifying integrity of the second public key using the first public key;
verifying integrity of the second boot image using the verified second public key when the integrity of the second public key is verified;
executing the second boot image when the integrity of the second boot image is verified;
maintaining a third boot image signed by the second manager;
verifying the integrity of the third boot image using the second public key; and
executing the third boot image when the integrity of the third boot image is verified.

2. The method for secure boot of a device of claim 1, wherein the second public key of the second manager is provided to be signed by the private key of the first manager and the third boot image is provided to be signed by the private key of the second manager.
